(19) United States
(12) Patent Application Publication
(10) Pub. No.: US 2015/0163339 A1
(43) Pub. Date: Jun. 11, 2015

(54) Communications indicator device

(71) Applicant: JAMES RANDOLPH FENTON, Hermosa Beach, CA (US)

(72) Inventor: JAMES RANDOLPH FENTON, Hermosa Beach, CA (US)

(21) Appl. No.: 14/121,846

(22) Filed: Oct. 23, 2014

Related U.S. Application Data
(60) Provisional application No. 61/961,798, filed on Oct. 24, 2013.

(51) Int. Cl. H04M 1/725

(52) U.S. Cl. CPC H04M 1/72527

(57) ABSTRACT

An indicator that may be configured to receive a signal from a communications device separate from the indicator is described. The indicator may include indication devices such as LEDs, audio speakers, vibrators or other indicator devices that may be engaged when the indicator may receive the signal. A communications device may be triggered to send the signal to the indicator by events that may meet programmed criteria.

This application claims priority from U.S. Provisional Patent Application Ser. No. 61/961,798, filed on Oct. 24, 2013, the entireties of which are expressly incorporated by reference herein.

### FIELD OF THE INVENTION

The field of the invention generally relates to a device that indicates the reception of digital communications. More specifically, the invention relates to a device that indicates the reception of digital communications that meet particular criteria on communications devices.

### BACKGROUND OF THE INVENTION

In today's “connected” world of email, voice mail and text messages, it is easy for a user of a digital communications device such as a smartphone or tablet computer to be overwhelmed with the high number of communications they may receive on the device.

At certain times during the day, a user may find it necessary to check each and every communication that they may receive on their digital devices. For instance, during work hours, they may receive phone calls and communications from a wide variety of people regarding a wide variety of topics that are important to their work functions, and each call or message may be important to receive and respond to in a timely fashion. In this scenario, the user may have their smartphone or tablet device set to emit an audio signal or ring tone, or to vibrate when a call is incoming or a message is received such that the call may be answered or the message may be immediately checked.

However, at other times, such as when the user may be in a meeting or doing a leisurely activity such as playing golf, the user may not find it convenient or even necessary to immediately check each and every communication that they may receive. In these cases, the user may turn off their ring tone or vibrate mode such that they may not be notified of any communications or messages that may be delivered, and therefore may not be disturbed. By turning off their ring tones or vibrate modes of their devices, they may be essentially making a decision not to be alerted to any calls or messages that they may receive, no matter how important the calls or messages may be. Accordingly, if a very important call or message may be received, they may not be alerted and may not know about the highly important call or message until they check their device at a later time. Because of this, and depending on the significance of the message, the user may be distraught because of the missed communication.

For instance, the user may miss a message from their spouse indicating that they have an emergency and need assistance. Or, the message may be regarding an opportunity that the user has been waiting eagerly to receive. It can be understood that in these scenarios, the user may have preferred to be alerted to the highly important calls or messages, but because they did not want to be alerted to all of their incoming “normal” messages, they had no choice but to make settings on their digital device that caused them miss the important messages as well.

In addition, there may be scenarios that the user may not be able to receive the message notification from their device that a call is incoming or that they have received a message. For instance, in the example of a user playing golf, the user may have placed their device in the pocket of their golf bag such that they may not be able to hear the ringer of an incoming call or feel the vibration that may exist when a communication may have been received. In these situations, the user may not know that any communications may have been received since they may not be able to hear the ringer or feel the vibration notifications triggered by the communications. And if any of the communications may be emergencies or other types of important or time sensitive messages, the user may be distraught that they may not have been immediately notified that these messages may have been received.

It can also be seen that types of events other than communications may also be useful to trigger the notification. For example, a user may wish to be notified of an approaching appointment that may be scheduled on a digital calendar on their smartphone.

Accordingly, there is a need for an improved indication device and method that may allow a user of a digital communications device to be alerted to events such as particular incoming calls or messages that may be sent to their communication device as well as other events while still having the ability to avoid being alerted to other messages they may receive.

### SUMMARY OF THE INVENTION

The present invention addresses the foregoing and other shortcomings of existing communication and indicator devices.

One aspect of the present invention regards a communications indicator that may comprise a housing, a receiver, an antenna, a controller, a power supply, an indicator device, a reset mechanism and other components.

Another aspect of the present invention regards a communications device, such as a smartphone, tablet computer or other device, that may be configured to send a signal to a communications indicator when said communications device may receive an incoming communication or message.

Another aspect of the present invention regards a communications indicator that may be configured to receive a signal from a communication device when said communications device may receive an incoming communication or message.

Yet another aspect of the present invention regards a communication indicator that may be configured to emit, display or otherwise transmit a notification, such as an illuminated LED, an audio signal, a vibration or other type of notification, to a user when said communications indicator may receive a signal from a communications device.

Another aspect of the current invention regards an app that may reside on the communications device or other device that may assist or otherwise enable the communications device to send a signal to the communications indicator when said communications device may receive an incoming communication or message.

Another aspect of the current invention regards a communication device or an app on a communications device that may allow the user to program specific criteria that incoming calls or messages must meet in order for the communication device to be triggered to send a signal to the communications indicator.

Another aspect of the current invention regards a communications device or an app on a communications device that may allow the user to program specific combinations of criteria that incoming calls or messages must meet in order for the communication device to be triggered to send a signal to the communications indicator.

Yet another aspect of the current invention regards a communications indicator that is configured with multiple indicator devices such as a variety of different colored LEDs, a vibrator, an audio speaker and other types of indicators.

Another aspect of the current invention regards a communications device or an app on a communications device that allows the user to program different criteria or combinations of criteria that incoming calls and messages must meet in order to trigger said communications device to send a signal to a communications indicator instructing it to employ different notification or indicator devices depending on the met criteria.

Another aspect of the current invention regards a communications device that may send different signals to a communications indicator that may respectively trigger the communications indicator to employ different indication devices.

Yet another aspect of the current invention regards a communications indicator that engages different indication devices depending on the particular signal it may receive from a communications device.

Another aspect of the current invention regards a communications indicator that has the ability to engage indicator devices in a variety of modes such as steady state, on/off patterns, blinking, and other patterns and modes, and in combinations of different patterns and modes depending on the signal it may receive from the communications device.

Another aspect of the current invention regards a communications device that may be triggered to send a signal to a communications indicator by events other than incoming communications or messages.

Another aspect of the current invention regards a communication indicator that may receive a signal from a communications device that may be triggered by events other than a communication to the communication device such that communications indicator may engage one or more indicator devices depending on the signal received.

Yet another aspect of the current invention regards an app or communications device that may store information regarding communications that may be received by the communications device.

Yet another aspect of the current invention regards an app or communications device that may report to the user particular data regarding communications that may have been received by the communications device.

Another aspect of the current invention regards a communications indicator that may enter into sleep mode when not in use and may then enter back into operational mode when triggered.

### BRIEF DESCRIPTION OF THE DRAWINGS

FIG. 1 is a component level view of a communications indicator and a front view of a communications device.

### DETAILED DESCRIPTION OF THE PREFERRED EMBODIMENTS

The current invention is now described with reference to the FIGURE. It should be noted that the scope of the current invention is not limited to the examples specifically shown and discussed herein, but also includes alternatives thereto.

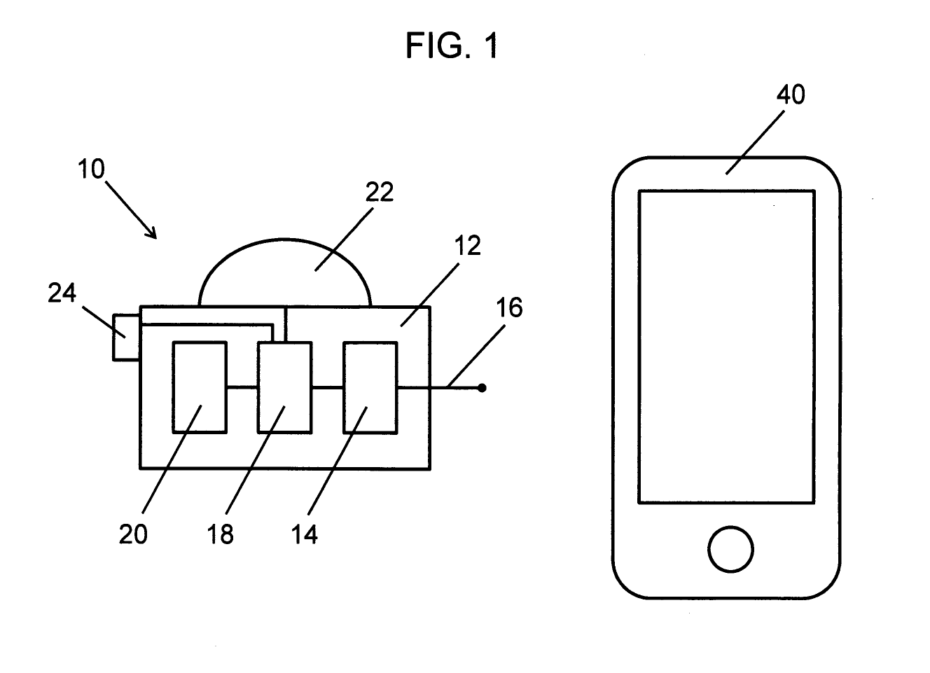

A preferred embodiment of the current invention is now described with reference to FIG. 1. FIG. 1 shows a side view component level diagram of a communications indicator 10 that may comprise a housing 12, a receiver 14, an antenna 16, a controller 18, a power supply 20, an indicator device 22, a reset mechanism 24 and other components. Note that while indicator device 22 may be described in this specification as an LED, it may also be a different type of indicator such as a different type of illuminator, a vibrating indicator, an audio speaker or other type of indicator device or combination of indicator devices. Communications indicator 10 may also include other components such as an ON/OFF switch (not shown) and other components. Also, communications indicator 10 may be designed and implemented as a component of a bracelet, a component of a necklace, a component of a lapel clip, in a housing to be held in one's pocket, as a part of another type of product or in another type of configuration.

One function of communications indicator 10 may be to receive a signal from a communications device 40 such as a smartphone, a tablet computer, a personal computer, a standard cell phone, or other type of communication device 40 when said communication device 40 may receive a communication such as a telephone call, a voice mail message, a text message, an email message, or other type of message, and to then notify the user that a communication has been received on the communication device 40. That is, when communication device 40 may receive a communication such as the type described above, said communication may act as a trigger that may trigger communications device 40 to send a signal to the communications indicator 10 notifying it that a communication has been received. When said signal may be transmitted from communication device 40 to communications indicator 10, receiver 14 may receive the signal through antenna 16 and may notify controller 18 that a signal has been received from the communication device 40. Once controller 18 has been notified that receiver 14 has received a signal from communications device 40, controller 18 may switch the indicator LED 22 to an ON state such that it may illuminate, thus indicating to the user that the communications device 40 has received a communication and that communications device 40 has informed the communications indicator device 10 of this fact. While indicator 22 has been described above as an LED, it may also be a different type of indicator such as a vibrator, and accordingly, may vibrate when the signal may be received from communications device 40, or an audio speaker, and accordingly, may emit an audio notification when the signal may be received from communications device 40, or another type of indicator.

It should be noted that power supply 20 may provide power to the components of communications indicator 10 including receiver 14, controller 18, indicator device 22 and other components.

The signal that may be transmitted from communication device 40 to communications indicator 10 may be a Bluetooth signal, a radio frequency (RF) signal, a millimeter wave signal, a modulated signal or other type of signal. It may be preferable that receiver 14 may be able to receive and interpret the type of signal that may be transmitted by communication device 40. It may also be necessary to “pair” or program the communications device 40 with the communications indicator 10 such that the two devices may communicate with each other as desired.

It should be noted that in some scenarios the communications device 40 may notify the communications indicator 10 of a real time communication such as a telephone call or video call such that the user may be able to answer the call in real time and speak with the caller or callers. In other scenarios, the communication device 40 may notify the communications indicator 10 of messages that may have been sent to or otherwise left on the communications device 40. Examples of such messages may be voice mail messages, email messages, text messages, video call messages and other types of messages.

Once indicator 22 may have been switched to an ON state by controller 18, the user may turn off indicator 22 and return communications indicator 10 to its default ready state by pressing reset button 24. Note that while reset button 24 has been depicted as a push button, it may be a different type of device such as a flip switch, a knob, a tape switch, a touch screen or other type of reset device.

In a preferred embodiment, the disclosed invention may also include an app or other type of software that may reside and run on communications device 40 or on another device such as a computer that may be connected to or in communications with communications device 40 or on another device. One function of the app may be to assist or enable the communications device 40 to identify an incoming call or a received message and to send a signal to the communications indicator 10 indicating the incoming call or that a message has been received. That is, the app may perform duties that may assist in this process such as scanning the communication device 40 for triggers such as incoming calls and received messages, and triggering the communications device 40 to send the signal to the communications indicator 10 when a call comes in or a message may be received. It should be noted that an app or other software may not be necessary and that the communications device 40 may perform all the necessary functions itself to accomplish the same end result as described above.

The app may also allow the user to set the communication device 40 to only notify communications indicator 10 of incoming communications or received communications that may meet one or more criteria.

For example, the app may allow the user of the communication device 40 and communications indicator 10 to choose the name of a person or persons who may call or send a communication to the communication device 40 that may trigger the communication device 40 to transmit a signal to communications indicator 10 notifying it of the call or the received communication. In this example, communication device 40 may only transmit a signal to communications indicator 10 when it may be receiving a communication or message from a particular person that may have been selected by the user and so set in the app. Accordingly, the user of communications indicator 10 may only be notified by the illumination of indicator LED 22 when communication device 40 may have received a communication or message from the particular person. Since other communications from other persons received by communication device 40 may not trigger communication device 40 to transmit a signal to communications indicator 10, the user of communications indicator 10 may not be notified of those other communications or messages received by other persons. It should be noted that the app may allow the user to easily program and select the names of the people they may wish to receive communications from, such as allowing the user to easily choose one name or multiple names from a contacts list on the app, from a contacts list on the communications device 40, from a contacts list on another device or by different means. The app may also allow the user to manually program the names of the people that they may wish to receive communications from without the use of a contact list. The app may also allow the user to un-select names to be excluded as desired. Also, it should be noted that an app may not be necessary and that the communications device 40 may have all the functionality built into itself to accomplish the aforementioned functionality.

It may be seen that this functionality may be very useful for users that may be involved in some type of activity where they do not wish to be disturbed by every communication that may be received by their communications device 40, but may wish to be notified if a particular person is attempting to contact them. For instance, a person playing golf may not wish to be notified of any communication on their communication device 40 other than a communication from their spouse. In this example, the person playing golf may keep their communication device 40 in their golf bag and may keep the communications indicator 10 somewhere easily visable such as on their body, clipped to the top of the golf bag, in the golf cart or in other places. For all communications that may be received on their communication device 40 other than from their spouse, they may not be notified. However, if their spouse attempts to contact them by calling them or by otherwise sending a message to their communication device 40, the communication device 40 may be triggered to send a signal to communications indicator 10 notifying it of the communication or message from the spouse, and communications indicator 10 may in turn illuminate its LED indicator 22. The person playing golf may see the illuminated indicator LED 22 and may then either answer the call or immediately check their communications device 40 for the communication or message sent from their spouse.

Note that the above example also demonstrates the current invention's usefulness in a scenario where the user of the communications device 40 may not physically be able to receive any type of notification from the communication device 40 directly that a call may be incoming or that a message may have been received due to the location of the communications device 40 itself. In the above example the communications device 40 may be placed in the pocket of a golf bag, and because of this location the user may not be able to hear an audio notification that may be emitted by the communications device 40, or feel a vibration notification that may be transmitted by the communications device 40, or otherwise receive any other type of notification from the communications device 40 that a call may be incoming or that a message may have been received. In this scenario, the user would miss all calls and messages sent to his communications device 40 whether he/she wished to receive notifications of such calls or messages from the communications device 40 or not. However, by using communications indictor 10, the user may be able to be notified of specific incoming calls or messages as described above.

In addition, the app or communications device 40 may also be set to exclude notifications of communications or messages originating from particular names while allowing notifications of communications and messages from other names, or any combination thereof. For example, if a user may be receiving a large number of email messages from a particular person and they do not wish to be notified of any further emails from that particular person while using their communication indicator 10, they may be able to choose the name of this particular person to be excluded from the notifications such that if this person sends them additional emails the user will not be notified of these communications by the communications indicator 10.

As mentioned in prior sections, in order to set the app to control communication device 40 to only notify communications indicator 10 that a call is coming in from a particular person, or that a message may have been received from a particular person, the app may allow the user of the communications device 40 to choose the name or names of the selected person or persons from a contact list that may exist on the app, on the communication device 40, or on another device such as a computer that may be connected to or may be in communication with the communication device 40 or app. In addition, the app may allow the user to simply enter in the name of the selected person or persons using a keyboard or other means into the app, into the communication device 40, or into another device such as a computer that may communicate with the communications device 40 or app. It may also be true that this functionality may be native on communications device 40 such that the use of an app to accomplish this functionality may not be necessary.

It should be noted that other types of criteria may be set and used to identify triggers that may trigger the communications device 40 to alert the communications indicator 10 of the incoming communication or a received message. For example, another type of message criteria that may be set to trigger the communications device 40 to send a signal to communication indicator 10 may include the type of message that may be received by the communications device 40. For instance, the app or communications device 40 may be set to only send a signal to communications indicator 10 if a text message is sent to communications device 40. In this example, communication indicator 10 may illuminate if communications device 40 receives a text message, but may not illuminate if communications device 40 receives a voice call or any other type of message such as a voice mail message or an email message. It should be noted that any type or types of messages, individually or in combination, may be set as a criteria in this scenario. For example, the user may choose for the communications device 40 to notify communications indicator 10 when voice mail messages or text messages may be received, but not email messages.

Another criteria that may be set to trigger communications device 40 to send a signal to communication indicator 10 notifying it that a message may have been received may include a requirement for keywords that may be in the subject line, in the body of the message, in both the subject line and the body of the message, in the voice mail message, or elsewhere in any type of communication. For instance, if the keywords “job” and “opportunity” are chosen as keywords and an email is sent to communications device 40 with these keywords in the subject line and/or in the body of the email itself, communications device 40 may notify communication indicator 10 that a message has been received by communications device 40. However, other messages that may be received by communications device 40 that may not contain these keywords in the subject line and/or body of the message may not trigger communications device 40 to send a signal to communications indicator 10. It should be noted that the app or the communication device 40 may need to have the ability to scan all types of messages that may be received by communications device 40, including listening to voice mail or video mail messages that may be received, in order to identify keywords for this functionality to be successful.

Other criteria that may be set to trigger communications device 40 to send a signal to communication indicator 10 notifying it of an incoming call or that a message may have been received may include a particular area code(s) of an incoming call. For instance, if the area code (310) is chosen as the criteria, any calls coming from the Los Angeles area code of (310), or any voice mails left from calls that may have come in from a number with the area code (310) may trigger communications device 40 to send a signal to communications indicator 10 notifying it that a communication has been received that may meet the set criteria. Multiple area codes may also be chosen. In addition, the app or communications device 40 may also be set to exclude notifications of communications originating from particular area codes while allowing notifications of communications originating from other area codes, or any combination thereof.

Other criteria or other combinations of criteria in addition to the aforementioned criteria may also be used to trigger communications device 40 to send a signal to communication indicator 10 notifying it that a message may have been received.

In addition, multiple criteria may be used as triggers to trigger communications device 40 to send a signal to communication indicator 10 notifying it of an incoming call or that a message may have been received. That is, a combination of the aforementioned criteria or other criteria may be used in combination. Also, multiple criteria may be set up and used with logic functions such as “if”, “and”, and “or” statements. For example, one criterion may be “if an email message is received from John Smith and the keyword “job” is in the subject line then notify the communications indicator 10 that a message has been received.” Other logical functions and combinations of logic functions may also be used.

It should also be noted that communications indicator 10 may include multiple indicator devices 22, such as multiple LEDs, vibrators, audio speakers or other indicators or combinations of indicator devices 22. In this case, communications device 40 may have the ability to send different signals to communications indicator 10 that may in turn instruct communications indicator 10 to engage different notification indicators 22. For example, communications indicator 10 may include an array of different colored LEDs. In this example, communications indicator 10 may have the ability to illuminate a particular color if the incoming call or messages to communications device 40 may meet certain criteria, and a different color if the incoming call or message to communications device 40 may meet different criteria.

Expanding on this example, the app or communications device 40 may have the ability to allow the user to select a particular color on the indicator 22 to be illuminated to notify them that a message may have been received by communications device 40 from a particular name of a person who may send a particular type of message. For example, the user may be able to set the color blue to represent their spouse, such that when the communications device 40 may receive an incoming call or a message from their spouse, the communications device 40 may send a particular signal to the communications indicator 10 that may instruct the communications indicator 10 to illuminate the blue LED such that the blue LED may illuminate thus notifying the user that their spouse is calling or has sent them a communication. In addition, the user may also set the color red to represent their employer such that when the communications device 40 may receive a call or a message from their employer, the communications device 40 may send a possibly different and particular signal to the communications indicator 10 that may instruct the communications indicator 10 to illuminate the red LED such that the red LED may illuminate thus notifying the user that their employer is calling or has sent them a communication. Other colors may be used for other names or other types of criteria. It should be noted that multiple names may also be set to illuminate the same color. In addition, other types of indicators 22 such as a vibrator or other indicator 22 may be set to be triggered when a particular message may be received by a particular name, or for other types of criteria.

Also, the app or communications device 40 may be set to trigger a different indicator 22 on communications indicator 10 depending on the type of communication that may be received by communications device 40. For example, the color red may be set to notify the user that a voice mail may have been received, and the color blue may be set to notify the user that an email message may have been received. It should be noted that any combination of criteria may be also set such that different indicators devices 22 may be triggered by different criteria, or combinations of criteria. One example of this may be that the color green may represent a text message that may be received by the user's spouse. Other indicator devices 22, such as the vibrator, audio speaker or other indicator 22, may be also be used in combination with any combination of criteria as described above.

In addition, different indicator devices 22 may also be triggered by different keywords that may be in the subject line, in the body of the messages, in the voice mail, or elsewhere in the messages. For example, the color yellow may be triggered if the keyword “mom” is anywhere in any communication that may be received by communications device 40.

Other indicator devices 22 may include fast blinking LEDs of different colors, slowly blinking LEDs of different colors, vibrators vibrating in a predetermined pattern (for example in continuous mode, in quick bursts, in slow bursts, etc.), a variety of different preprogrammed or programmable audio sounds and ringtones, music, and other types of indicators functioning in a variety of patterns or modes. Also, one type of indicator 22 or mode of indicator 22 may be set to represent a type of message or other criteria while another type of indicator 22 or mode of indicator 22 may be set to represent different criteria such as a person's name, and these indicator devices 22 may be programmed to operate in combination. For example, the color blue may be set to represent a message from a particular person's name, and the vibrator may be set to represent a particular type of message. In this example, a blue LED illumination coupled with the vibrator vibrating in continuous mode may represent an email message from a spouse. In another example, the color green with a blinking pattern may be set to signify an incoming call from a spouse, and if the user misses the call, the LED may transition to a non-blinking green to signify that the user's spouse had called, that the call was missed and that a voice mail message was left. Other combinations of indicators and other combinations of criteria may also be used.

It should be noted that while the above descriptions may pertain to communications device 40 being triggered to send a signal to communications indicator 10 when communications device 40 may receive an incoming call, message or other type of communication, communication device 40 may also be triggered to send a signal to communications indicator 10 by other events or triggers. One such other event or trigger that may trigger communications device 40 to send communications indicator 10 a signal may include a scheduled appointment on a digital calendar that may reside on communications device 40, on an app on communications device 40 or in another place. For example, the user of communications device 40 may have a doctor's appointment scheduled on a digital calendar on their communications device 40, and communications device 40 may be set to send a signal to communications indicator 10 at a predetermined amount of time prior to the scheduled doctor's appointment in order to alert the user that the appointment may be approaching. Using the same example as above in other sections of this specification, if communications device 40 was to be placed in the pocket of a golf bag while the user was playing golf such that the user may not be physically able to receive notifications directly from communications device 40, and communications indicator 10 was placed in a position that it may be visible to the user, communications indicator 10 may engage an indicator device 22 such as an LED upon receiving a signal from communications device 40 that a scheduled appointment was drawing near such that the user may receive the notification from communications indicator 10 and may make arrangements to not miss the appointment.

As with other descriptions and details above pertaining to communications indicator 10 receiving a signal from communications indicator 40 when communication events may meet particular criteria, the same may be true for all other triggers or events that may trigger communications device 40 to send communications indicator 10 a signal to engage an indicator device 22. For example, criteria may include the names of particular people that the appointments must be with in order to trigger communications device 40 to send a signal to communications indicator 10. Other types of criteria may include the type of appointment and the importance level of the appointment which may be set. Other types of criteria and/or combinations of criteria may also be programmed.

In addition, communications device 40 may send different signals to communications indicator 10 depending on different criteria that may be met by different types of events that may trigger communications device 40 to send a signal to communications indicator 10 such that communications indicator 10 may engage different notification devices 22 depending on the signals received. That is, as with other descriptions and details above pertaining to communications indicator 10 receiving a signal from communications indicator 40 when communication events may meet particular criteria, and engaging a particular indicator device 22 depending on the signal that may be received, the same may be true for all other events or triggers that may trigger communications device 40 to send communications indicator 10 a signal to engage one or more indicator devices 22. For example, communications device 40 may be programmed to send communications indicator 10 a particular signal instructing communications indicator 10 to illuminate a blue LED when communications device 40 may be triggered by an approaching appointment with a particular person. Other types of criteria and/or combinations of criteria may also be programmed for events other than communication events.

In general, it can be seen that the subject matter described in above sections for communications device 40 being triggered by an incoming communication or message to send communications indicator 10 a signal such that communications indicator 10 may engage one or more indicator devices 22 depending on the signal that may be received may also apply to communications device 40 being triggered by triggers or events other than communications or messages to send a signal to communications indicator 10 instructing communications indicator 10 to engage one or more indicator devices 22 depending on the signal received.

Other types of triggers or events that may trigger communications device 40 to send communications indicator 10 a signal to engage notification devices 22 may include a particular date, a time of the day, an alarm set on an alarm clock within the communications device or on an app residing on the communications device, a reminder programmed into communications device 40 or into an app residing on communications device or other place, the countdown of a stopwatch or timer on communications device 40 or on an app residing on communications device 40, a notification from another app such as a Facebook app or a Twitter app that may reside on communications device 40, or from other types of events.

The communications indictor 10, app or communications device 40 may also have the functionality to store all or subsets of all information regarding any communications that may be received by the communications device 40 such as the sender's names, types of messages, different types of criteria that may have been met such as keywords and other information. The communications indicator 10, app or communications device 40 may also be able to deliver this information to the user in a wide variety of formats or reports and filtered according to the user's needs and desires. In one example, the app or communications device 40 may be able to store what messages where received that may have met particular criteria as set up by the user. In this case, the app or communications device 40 may store information such as time of message and other information for user to retrieve at a later time. For example, the user may wish to see a listing of all messages that may have included particular keywords and that may have been sent by particular contacts during a particular time interval. Other criteria or combinations of criteria may also be set and used to generate the data listings or reports.

The communications indicator 10, app or communications device 40 may also have the functionality to identify and notify the user of particular “selected” contacts that may not have sent the user a communication meeting particular criteria or no particular criteria for a specific period of time.

The communications indicator 10, the app or communications device 40 may also have the ability to be set to enter into a sleep mode in order to conserve battery power after a predetermined period of time of non-use. The communications indicator 10, app or communications device 40 may be triggered to leave sleep mode and return to normal operational mode by the user, by the reception of a communication, or by other means.

The business method of the present invention may include online sales of the communications indicator 10, communications device 40 and app, brick-and-mortar retail store sales of communications indicator 10, communications device 40 and app, direct response sales (television, radio or other direct response channels) of the communications indicator 10, communications device 40 and app, and other methods.

The present invention includes a number of aspects and features which may be practiced alone or in various combinations or sub-combinations, as desired. While preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. An indicator, comprising:
a receiver; and
an indicator device;
wherein a communications device separate from indicator may send indicator a signal;
wherein indicator may engage indicator device upon receiving a signal from communications device.

2. The device of claim 1, wherein the indicator device is an LED.

3. The device of claim 1, wherein the indicator device is an audio speaker.

4. The device of claim 1, wherein the indicator device is a vibrator.

5. The device of claim 1, wherein the communications device is a smartphone.

6. The device of claim 1, wherein the communications device is a tablet computer.

7. An indicator, comprising:
a receiver; and
at least one indicator device;
wherein a communications device separate from indicator may send a signal to indicator when communications device may receive a trigger;
wherein, indicator may engage indicator device upon receiving a signal from communications device.

8. The device of claim 7, wherein the trigger is a voice call.

9. The device of claim 7, wherein the trigger is an email.

10. The device of claim 7, wherein the trigger is a text message.

11. The device of claim 7, wherein the trigger is a voice mail message.

12. The device of claim 7, wherein the trigger is an appointment on a calendar.

13. An indicator, comprising:
a receiver; and
at least one indicator device;
wherein a communications device separate from indicator may receive a trigger that may meet criteria;
wherein communications device may send a signal to indicator when communications device may receive a trigger that may meet criteria;
wherein, indicator may engage indicator device upon receiving a signal from the communications device.

14. The device of claim 13, wherein the criteria may be that the name of the person sending a communication to the communication device must match a pre-defined name.

15. The device of claim 13, wherein the criteria may be that the type of message sent to the communication device must match a pre-defined message type.

16. The device of claim 13, wherein the criteria may be that a communication sent to the communication device must include a pre-defined keyword.

17. The device of claim 13, wherein the communications device may send a particular signal to the indicator depending on what criteria may be met by the trigger and the indicator may engage a particular indicator device depending on the particular signal received.
